(19) United States
(12) Patent Application Publication
(10) Pub. No.: US 2019/0215163 A1
(43) Pub. Date: Jul. 11, 2019

(54) ELECTRONIC CUSTODY TRACKING

(71) Applicant: Ford Global Technologies, LLC, Dearborn, MI (US)

(72) Inventors: Ali Mohamad Suleiman, Dearborn, MI (US); Mohamad Nasser, Dearborn Heights, MI (US); Vijay Jayaraman, Novi, MI (US); Karl Nathan Clark, Belleville, MI (US); John Naum Vangelov, South Lyon, MI (US)

(73) Assignee: Ford Global Technologies, LLC, Dearborn, MI (US)

(21) Appl. No.: 15/866,331

(22) Filed: Jan. 9, 2018

(51) Int. Cl. H04L 9/32; H04L 29/06; H04L 9/06; H04L 9/14; H04L 9/30

(52) U.S. Cl. CPC H04L 9/3247; H04L 63/0428; H04L 63/06; G07C 9/00119; H04L 9/14; H04L 9/30; H04L 9/0637

(57) ABSTRACT

A computer includes a processor and a memory. The processor is programmed to receive custody data for a vehicle and store the custody data in a vehicle ledger. The processor is further programmed to receive a request to open encrypted communications between an access device and the computer based on a session key and validate the request based on the custody data. The process is further programmed to control the vehicle based on the encrypted communications.

### BACKGROUND

Transferring vehicle custody typically involves physically transferring access devices (e.g. fobs) from one owner to another. Sometimes, access devices are lost or forgotten. In addition, in some cases, either a current or a subsequent user of the vehicle may wish to retain their current access device.

### BRIEF DESCRIPTION OF THE DRAWINGS

FIG. 1 is a block diagram of an exemplary system for maintaining a vehicle ledger.

FIG. 2 is a diagram of an exemplary process for transferring custody from an originator to a first user.

FIG. 3 is a diagram of an exemplary process for transferring custody from a first user to a second or subsequent user.

FIG. 4 is diagram of an exemplary process for accessing a vehicle with an access device.

### DETAILED DESCRIPTION

A computer includes a processor programmed to receive custody data for a vehicle and store the custody data in a vehicle ledger. The processor is further programmed to receive a request to open encrypted communications between an access device and the computer based on a session key. The processor is further programmed to validate the request based on the custody data; and control the vehicle based on the encrypted communications.

In an example, the custody data can include a public key for the access device, and the request is can be signed by a private key for the access device. In another example, the custody data can be received from a blockchain network.

The processor can be further programmed to validate the custody data. In an example, the custody data is signed by a private key from a user having custody of the vehicle prior to a custody transfer, and validating the custody data is based at least in part on the custody data being signed by the private key. In another example, validating the custody data is based on a public key from the user having custody to the vehicle prior to the custody transfer stored in the memory of the computer prior to receiving the custody data.

The processor can be further programmed to generate a digital vehicle key signed by a vehicle private key; and provide the digital vehicle key to the access device. In an example, providing the digital vehicle key to the access device can include storing the digital vehicle key in a blockchain system.

The processor can be further programmed to generate the session key, and send the session key to the access device.

In an example, the custody data can include an electronic key authority, signed by a private key of a user having custody of the vehicle prior to a custody transfer of the vehicle. In another example, the vehicle ledger includes custody data from each entity that previously had custody of the vehicle.

A method includes receiving custody data for a vehicle and storing the custody data in a vehicle ledger. The method further includes receiving a request to open encrypted communications between an access device and the computer based on a session key and validating the request based on the custody data. The method further includes controlling the vehicle based on the encrypted communications.

In an example, the custody data includes a public key for the access device, and the request is signed by a private key for the access device. In another example, the custody data is received from a blockchain network.

The method can further include validating the custody data. In an example, the custody data is signed by a private key from a user having custody to the vehicle prior to a custody transfer of the vehicle and validating the custody data is based at least in part on the custody data being signed by the private key. In another example, validating the custody data is further based on a public key from the user having custody to the vehicle prior to the custody transfer stored in a memory of the computer prior to receiving the custody data.

The method can further include generating a digital vehicle key signed by a vehicle private key; and providing the digital vehicle key to the access device. The method can further include generating the session key; and sending the session key to the access device.

In an example, the vehicle ledger can include custody data from each entity that previously had custody of the vehicle.

Further disclosed is a computer including a processor programmed to execute any one of the above method steps. Yet further disclosed is a vehicle including the computer. Yet further disclosed is computer program product, including a computer readable medium storing instructions executable by a processor, to execute any of the above method steps.

An electronic record of custody can provide tracking of access device authorization for accessing a vehicle. Custody of a vehicle is defined herein as having authorized access to the vehicle. The electronic record of custody may be maintained, for example, by a computer on the vehicle. Additionally or alternatively, maintaining a record of custody on blockchain provides for the use of a distributed database.

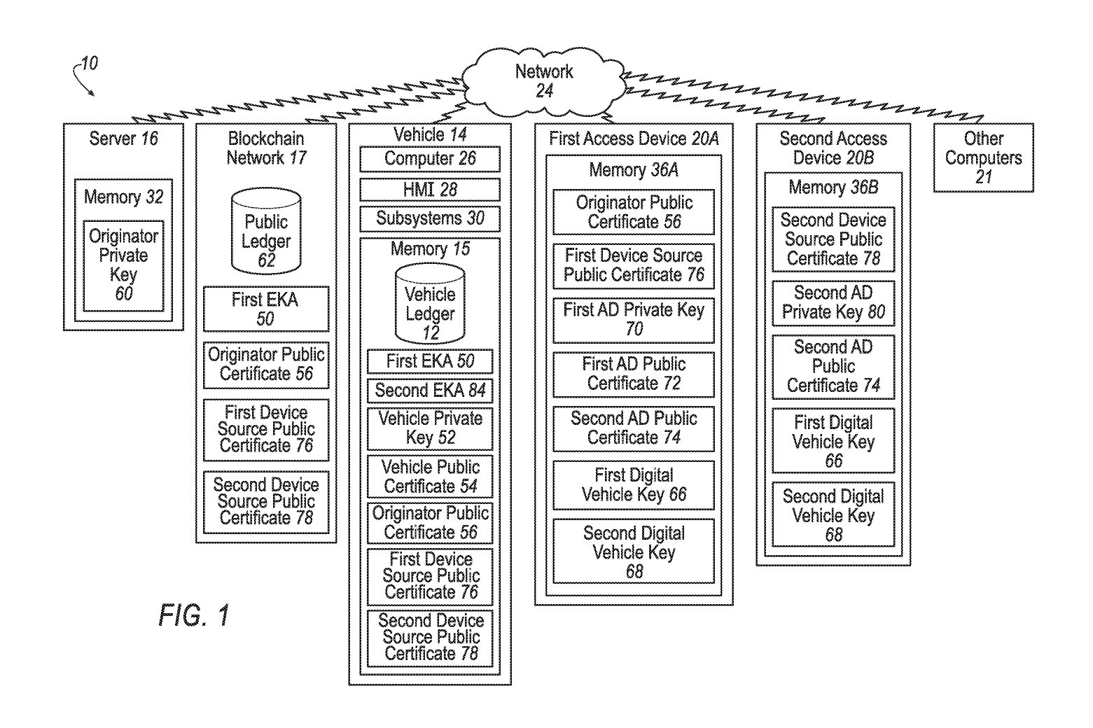

FIG. 1 is a diagram of an exemplary system 10 for maintaining a vehicle ledger 12 in a memory 15 in a vehicle 14. The memory is communicatively coupled with a computer 26 in the vehicle 14. The vehicle ledger 12 is a trusted electronic record of custody data for the vehicle 14. Custody data includes data indicating a history of access devices 20 such as the first and second access devices 20A, 20B authorized to access the vehicle 14 and the respective time periods of authorization. Custody data further includes data identifying users of the respective access devices 20 authorized to access the vehicle 14. The vehicle ledger 12 is stored in a computer memory such as the computer memory 15 in the vehicle 14. As described in detail below, the vehicle ledger 12 is updated with each change of custody for the vehicle 14 to provide the electronic record of custody.

In addition to maintaining the vehicle ledger 12 in the memory 15, the system 10 may maintain a public ledger 62 on a blockchain network 17. The blockchain network 17 includes a plurality of computers connected in a peer-to-peer network. A blockchain is an electronic record of transactions included in blocks of data linked together in a chain such that a block of data cannot be altered without altering every subsequent block in the chain. The public ledger 62 is a blockchain and may include a record of custody for the vehicle 14. Maintaining the record of custody on the public ledger 62 has the advantage of using a distributed database. A distributed database is a database that is distributed and maintained over a plurality of computers. In this case the blockchain network 17 includes a plurality of computers and the public ledger 62 is distributed over computers included in the blockchain network 17.

The system 10 includes the vehicle 14, a server 16, a first access device 20A and a second access device 20B. Additionally, the system 10 optionally includes a blockchain network 17 and other computers 21. The vehicle 14, the server 16, the blockchain network 17, other computers 21, and the first and second access devices 20A, 20B may be communicatively coupled to one another via a network 24. The term “communicatively coupled,” as used herein, means that the components can communicate via wired or wireless communications and can exchange digital instructions and/or data. The term “access device 20” refers herein to an access device such as one of the first and second access devices 20A, 20B. As described in additional detail below, the access devices 20 are electronic devices that communicate with vehicle 14 and allow a user to perform operations such as locking and unlocking the vehicle 14.

For ease of discussion, the system 10 is shown to include one vehicle 14, one server 16, one blockchain network 17 and two access devices 20. The system 10 may, however, include any number of vehicles 14, servers 16, blockchain networks 17 and access devices 20.

The vehicle 14, server 16, blockchain network 17, and access devices 20 generate, store, and exchange electronic records to maintain the vehicle ledger 12, and manage the authorization of access devices 20 to access the vehicle 14. Table 1, included herein, provides a list of electronic records, including definitions and usages of the electronic records, that may be used by the system 10.

The vehicle 14 is generally a land-based vehicle, e.g., a motorcycle, a passenger car, light truck, etc. The vehicle 14 includes a computer 26, the memory 15, a human-machine interface (HMI) 28 and a plurality of subsystems 30.

The computer 26 includes one or more processors and the memory 15. The computer 26 may include and/or be communicatively coupled to one or more other computers, including the HMI 28 and the plurality of subsystems 30 which likewise may include respective processors and memories.

As described in additional detail below, the computer 26 is programmed to maintain the vehicle ledger 12. The computer 26 is further programmed to determine, based on electronic records stored in the memory 15, authorization for computers such as server 16 and the blockchain network 17 to update the vehicle ledger 12. The computer 26 is still further programmed to determine an authorization of the access devices 20 to access the vehicle 14. The computer 26 is still further programmed to encrypt and decrypt communications with the access devices 20. The computer 26 is still further programmed to transfer authorization to access the vehicle 14 from a first access device 20A to a second access device 20B.

Communications, i.e., communicative coupling, with the computer 26 may be achieved via a controller area network (CAN) bus or local interconnect network (LIN) bus, a wired and/or wireless in-vehicle local area network (LAN), e.g., using wired or wireless technologies such as Wi-Fi®, Bluetooth®, etc., as is known. Communications include communications with devices external to the vehicle 14 such as the server 16, the blockchain network 17 and the first and second access devices 20. Additionally, communications with the computer 26 includes communications with vehicle components such as the HMI 28 and subsystems 30.

The memory 15 includes one or more types of computer-readable media, and storing instructions executable by the processors for performing various operations, including as disclosed herein. The memory 15 stores a plurality of electronic records that can be used to track vehicle custody, track authorization of access devices 20 for accessing the vehicle 14, and encrypt and decrypt transmissions between the computer 26, the server 16, the blockchain network 17 and the access devices 20.

The plurality of electronic records stored in the memory 15 includes a first electronic key authority (EKA) 50, a vehicle private key 52, a second EKA 84, a first vehicle public certificate 54, an originator public certificate 56, a vehicle identification number (VIN) 58, a first device source public certificate 76 and a second device source public certificate 78 and the vehicle ledger 12. Definitions and usages of the electronic records appear in Table 1 below.

The human-machine interface (HMI) 28 provides one or more mechanisms for a user of the vehicle 14 to interface with the computer 26. The HMI 28 may include one or more input and/or output devices including knobs, switches, audio inputs (microphones), audio outputs (speakers) and visual output devices such as lamps, display screens, projected displays, etc. The HMI 28 may further include interactive voice response (IVR) and/or a graphical user interfaces (GUIs), including touchscreen displays, gesture recognition systems, etc. The HMI 28 may include one or more computers, each of the computers including one or more processors and memories.

The server 16 is a computer including a memory 32 and one or more processors. The server 16 is programmed to store and/or generate one or more electronic records. The electronic records include an originator private key 60. A private key is a digital code for use in asymmetric encryption that is unique to a first computer such as the server 16 and intended to be kept secret. The private key has a mathematical relationship with a public key associated with the first computer such that second computers that have a copy of the public key can communicate securely with the first computer, without knowing the private key.

The server 16 is programmed to generate the first electronic key authority (EKA) 50, sign the first EKA 50 with the originator private key 60 and send the first EKA 50 to one or more other computers or computer systems such as the blockchain network 17 and/or the computer 26 in the vehicle 14. Signing the first EKA 50 with the originator private key 60 is defined as modifying the first EKA 50 based on data included in the originator private key 60 according to an algorithm.

The blockchain network 17 includes a plurality of computers linked in a peer-to-peer network. Each of the computers includes one or more processors and memory. The blockchain network 17 The memory 34 includes a list of electronic records referred to as blocks. The blocks are secured by cryptology and are continuously growing by appending new data. New blocks include links to previous blocks in a chain referred to as a blockchain. Linking the blocks may increase a level of security. The blockchain network 17 includes electronic records such as a public ledger 62 and the first EKA 50. Definitions and usages of the electronic records appear in Table 1 below.

The blockchain network 17 is programmed to receive an electronic key authority (EKA), for example the first EKA 50 from the server 16, and to generate and/or update a public ledger 62 based on the first EKA 50. The blockchain network 17 is further programmed to receive subsequent EKAs associated with subsequent transfers of custody of the vehicle 14, and append the subsequent EKAs to the public ledger 62. In this manner, the blockchain network 17 maintains a complete history of custody for the vehicle 14 in the public ledger 62.

The system 10 includes a plurality of access devices such as the first and second access devices 20A, 20B. Examples of access devices include key fobs, mobile telephones, tablets and other computing devices (typically mobile) that are programmed to access the vehicle 14.

Each of the first and second access devices 20A, 20B includes one or more processors and a respective memory 36A, 36B (collectively memories 36). Each of the access devices 20, is programmed to transmit encrypted instructions to the vehicle 14 such that a user of the respective access device 20 can operate one or more subsystems 30 of the vehicle 14. The encrypted instructions may include, for example, encrypted instructions to unlock the door, lock the door, open the trunk, turn the ignition on or off, turn vehicle lights on or off, etc.

The first and second access devices 20A, 20B store a plurality of electronic records in their respective memories 36A, 36B. The plurality of electronic records may be used to control communications with and access to the vehicle 14.

The electronic records included in the memory 36A of the first access device 20A may include the originator public certificate 56, a first digital vehicle key 66, a second digital vehicle key 68, a first access device (AD) private key 70, a first access device (AD) public certificate 72, a second access device (AD) public certificate 74, and a first device source public certificate 76. The electronic records included in the memory 36B of the second access device 20B may include the first digital vehicle key 66, the second digital vehicle key 68, a second access device private key 80, a second access device (AD) public certificate 82, and a second device source public certificate 78. Definitions and usages of the electronic records appear in Table 1 below.

Generally, each of the first and second access devices 20A, 20B are sourced by a respective source. Each source may be, e.g., a manufacturer or supplier for the respective first and second access device 20A, 20B. In some cases, the source for each of the first and second access devices 20A, 20B may be the same.

As used herein, the first digital vehicle key 66 is a first digital vehicle key to be used by the first access device 20A to access the vehicle 14 and the second digital vehicle key 68 is a second digital vehicle key to be used by the second access device 20B to access the vehicle 14. In addition to the first and second digital vehicle keys 66, 68, the first and second access devices 20A, 20B may contain a plurality of digital vehicle keys to be used for access to one or more other vehicles. In this manner, a single access device 20 may be able to access a plurality of vehicles.

The first and second access devices 20A, 20B are programmed to communicate with the vehicle 14. For example, the first access device 20A may receive the first digital vehicle key 66 from the vehicle 14. As another example, the first access device 20A may receive an instruction from the vehicle 14 to revoke the first digital vehicle key 66. Receiving an instruction from the vehicle 14 is defined herein to mean receiving the instruction from a computer such as the computer 26 in the vehicle 14.

Still further, the first and second access devices 20A, 20B may be programmed to communicate with each other. For example, the second access device 20B may transmit a second access device public certificate 74 to the first access device 20A, via the network 24.

The system 10 may include one or more other computers 21. The other computers 21 may be used, for example, by users of vehicle 14 to input data to the system 10 at a time of a transfer of custody of the vehicle 14 from a first user to a second user.

The network 24 is one or more mechanisms by which the vehicle 14, the server 16, the blockchain network 17, and the first and second access devices 20A, 20B communicate with each other, and may be one or more of various wired or wireless communication mechanisms, including any desired combination of wired (e.g., cable and fiber) and/or wireless (e.g., cellular, wireless, satellite, microwave and radio frequency) communication mechanisms and any desired network topology (or topologies when multiple communication mechanisms are utilized) including point-to-point communications mechanisms. Exemplary communication networks include wireless communication networks (e.g., using one or more of cellular, Bluetooth®, IEEE 802.11, etc.), local area networks (LAN) and/or wide area networks (WAN), including the Internet, providing data communication services.

The types of wireless communications may include one or more of cellular, Bluetooth®, IEEE 802.11 (typically, Wi-Fi®), dedicated short range communications (DSRC), two-way satellite (e.g., emergency services), one-way satellite (e.g., receiving digital audio radio broadcasts), AM/FM radio, etc.

As discussed above, the system 10 utilizes a plurality of electronic records to track the custody of the vehicle 14 and to secure access to the vehicle 14. Table 1 includes a list of electronic records together with definitions and usages. The list of electronic records in Table 1 is not limiting. Other electronic records, in addition to the electronic records listed in Table 1, may be used to track custody and secure access to the vehicle 14.

TABLE 1

| Name | Definition | Usage |
|---|---|---|
| Originator | A private key for a computer | Used for signing the Electronic Key |
| Private Key 60 | associated with the originator of | Authorities (EKAs) such as the First |
| | the vehicle 14. Has a | EKA 50 to whoever receives custody of |
| | mathematical relationship with | the vehicle 14 from the originator. Also |
| | the originator public key | used to sign vehicle public certificates |
| | included in the Originator | such as the First Vehicle Public |
| | Public Certificate 56. | Certificate 54. |
| Originator | An electronic record that | Used for checking the validity of |
| Public | includes identification data for | Vehicle Public Certificate 54, and the |
| Certificate 56 | the originator of the vehicle 14, | First EKA 50. It is installed on the |
| | and the originator public key. | vehicle 14 and access devices 20 by the |
| | This can also be referred to as | originator. |
| | the root certificate authority | |
| | (CA) from the originator that | |
| | built the vehicle 14. | |
| Vehicle Private | A private key for a computer | The vehicle private key 52 is used to |
| Key 52 | associated with the vehicle 14. | sign digital vehicle keys such as the first |
| | Has a mathematical relationship | digital vehicle key 66 and second digital |
| | with the vehicle public key | vehicle key 68 which are issued to |
| | included in the First Vehicle | access devices 20. |
| | Public Certificate 54. | |
| First Vehicle | An electronic record provided | Used for encryption of messages sent to |
| Public | by the computer associated with | the vehicle 14 and verifying signatures |
| Certificate 54 | the vehicle 14 to other | of information from the vehicle 14. The |
| | computers. It is used for | First Vehicle Public Certificate 54 is |
| | encryption of messages sent to | signed by the originator private key 60. |
| | the vehicle 14 and verifying | Can be used for checking the signature |
| | signatures of information from | of digital vehicle keys (e.g., the first |
| | the vehicle 14. The First | digital vehicle key 66) by the access |
| | Vehicle Public Certificate 54 is | devices 20 (e.g., the first access device |
| | signed by the originator private | 20A). |
| | key 60. | |
| Public Ledger 62 | A distributed database that | Can be used to store transfer of custody |
| | utilizes blockchain technology. | transactions for one or more vehicles 14. |
| Vehicle Ledger | The trusted history of custody | Used to trace trust all the way back to |
| 12 | for a vehicle 14. | the originator public key included in the |
| | | Originator Public Certificate 56 and to |
| | | determine who currently has custody of |
| | | the vehicle 14. |
| Electronic Key | An electronic record that serves | The EKA is used to verify commands |
| Authority | as an entry in the vehicle ledger | from the person that currently has |
| (EKA), for | 12 and in some cases the public | custody of the vehicle 14, if it is the |
| example, the | ledger 62. Indicates custody of | latest EKA in the Vehicle Ledger 12. |
| First EKA 50. | the vehicle 14 at a time when | All prior EKA's are used to trace trust |
| | the EKA is current. | all the way back to the originator. |
| Digital vehicle | An electronic record that | Used as a receipt sent from the vehicle |
| key, for example | indicates receiving control over | 14 to the access device 20 indicating |
| the First digital | the vehicle 14. | that it will now accept commands from |
| vehicle key 66 | | that access device 20. |
| and second | | |
| digital vehicle | | |
| key 68 | | |
| First Access | A private key for the First | Used for signing commands sent to the |
| Device (AD) | Access Device 20A. Has a | vehicle 14. |
| Private Key 70 | mathematical relationship with | |
| | the First Access device Public | |
| | Key included in the First | |
| | Access Device Public | |
| | Certificate 72. | |
| First Access | An electronic record provided | Used by the vehicle 14 to confirm the |
| Device (AD) | by the First Access Device 20A | identity of the First Access Device 20A |
| Public | to other computers. Includes | when receiving commands. |
| Certificate 72 | information for the user having | |
| | custody, first access device | |
| | serial number, and the First | |
| | Access Device Public Key. It is | |
| | signed by the First Access | |
| | Device Source using the first | |
| | access device private key 70. | |
| Second Access | A private key for the Second | Used for signing commands sent to the |
| Device (AD) | Access Device 20B. Has a | vehicle 14. |
| Private Key 80 | mathematical relationship with | |
| | the Second Access Device | |
| | Public Key included in the | |
| | Second Access Device Public | |
| | Certificate 74. | |
| Second Access | An electronic record provided | Used by the vehicle 14 to confirm the |
| Device (AD) | by the Second Access Device | identity of the Second Access Device |
| Public | 20B to other computers. | 20B when receiving commands. |
| Certificate 82 | Includes information for the | |
| | user having custody, second | |
| | access device serial number, | |
| | and the Second Access Device | |
| | Public Key. It is signed by the | |
| | Second Access Device Source | |
| | using the second access device | |
| | private key 80. | |
| Access Device | A unique code assigned to the | Used to uniquely identify an access |
| Serial Number | access device 20. | device. |
| First Device | A private key for the source | Used to sign First AD Device Public |
| Source Private | (e.g., manufacturer) of the First | Certificate 72. |
| Key | Access Device 20A. Has a | |
| | mathematical relationship with | |
| | the First Device Source Public | |
| | Key included in the First | |
| | Access Device Public | |
| | Certificate 72. | |
| First Device | An electronic record provided | Used to validate that the First Access |
| Source Public | by a computer associated with | Device 20A was sourced by an |
| Certificate 76 | the source (e.g. manufacturer) | authorized device source. |
| | of the First Access Device 20A | |
| | to other computers. | |
| Second Device | A private key for the source | Used to sign Second Access Device |
| Source Private | (e.g., manufacturer) of the | Public Certificate 72. |
| Key | Second Access Device 20B. | |
| | Has a mathematical relationship | |
| | with the Second Device Source | |
| | Public Key included in the | |
| | Second Access Device Public | |
| | Certificate 74. | |
| Second Device | An electronic record provided | Used to validate that the Second Access |
| Source Public | by a computer associated with | Device 20B was sourced by an |
| Certificate 78 | the source (e.g. manufacturer) | authorized device source. |
| | of the Second Access Device | |
| | 20B to other computers. | |
| Signature | An electronic signature that can | |
| | be confirmed using a | |
| | corresponding public certificate. | |
| | An example method would be | |
| | x509 Code Signing. If x509 is | |
| | used the public certificates | |
| | would be replaced with | |
| | certificate authorities (CAs) that | |
| | are signed by Root Certificate | |
| | Authorities. | |

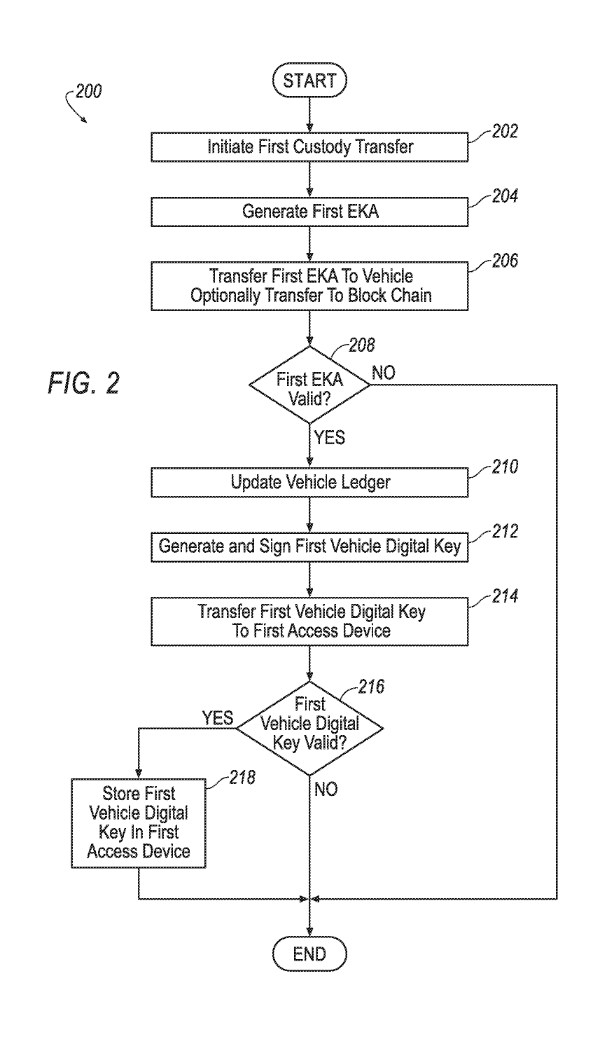

FIG. 2 is a diagram of an exemplary process 200 for transferring custody of the vehicle 14 from an originator to a first user. The originator is the first person or entity, e.g., a manufacturer or initial supplier to have custody of the vehicle 14. The process 200 begins in a block 202.

In the block 202, the originator initiates a transfer of custody of the vehicle 14. For example, the originator may input data to the server 16 indicating that a first user is entitled to custody of the vehicle 14. The data includes, e.g., the first access device public certificate 72 for the first access device 20A, used by the first user. An exemplary first access device public certificate 72 is shown below.

First Access Device
Public Certificate 72

| | |
|---|---|
| First Access Device 20A Serial | Unique number identifying the first |
| Number | access device 20A |
| First Access Device Public Key | digital code |
| Date/Time Manufactured | 2017-10-25T18:42:24.999 (example) |
| First user | First user identification data |
| Signature | Signed by First Device Source Private |
| | Key |

The first access device public certificate 72 includes a serial number uniquely identifying the first access device 20A. The first access device public certificate 72 further includes a first access device public key. The first access device public key is a digital code. The first access device public key can be used, for example, by the vehicle 14 to confirm the identity of the first access device 20A when receiving commands. The first access device public key can further be used to encrypt data sent from the vehicle 14 to the first access device 20A. The first access device public certificate 72 may further include first user data such as name, address, etc. The first access device public certificate 72 is signed by an authorized entity, for example a source of the first access device 20A.

In addition to the first access device public certificate 72, other data may be input to the server 16 such as payment information, date of delivery of the vehicle 14, etc. The process 200 continues in a block 204.

In the block 204, the server 16 generates the first electronic key authority (EKA) 50 and signs the first EKA 50 with the originator private key 60 for the vehicle 14. The first EKA 50 is shown below.

First Electronic Key Authority 50

| | |
|---|---|
| Granter Public Certificate | Checksum of Originator Public |
| Checksum | Certificate 56 |
| Granter Public Certificate Serial | Serial number from the Original |
| Number | Public Certificate 56 |
| Date/Time | 2017-10-24T18:42:24.999 (example) |
| VIN | Vehicle identification number |
| First User Access Device Public | First Access Device Public |
| Certificate | Certificate 72 |
| Signature | Signed by Originator Private Key 60 |

The first EKA 50 includes a checksum of the originator public certificate 56, a serial number or other unique identification of the originator public certificate 56, the vehicle identification number (VIN) for the vehicle 14, and the date and time of the transfer of custody. A checksum is a number generated by a calculation performed on an electronic record. The checksum can be used to identify a file or confirm its integrity. The serial number or other unique identification of the granter public certificate 56 provides a second form of identification. The first EKA 50 is signed based on the originator private key 60. The process 200 continues in a block 206.

In the block 206, the server 16 transfers the first EKA 50 to the computer 26 in the vehicle 14. The transfer may include an intermediate transfer to the blockchain network 17.

In the case that the transfer includes an intermediate transfer to the blockchain network 17, the server 16 transfers the first EKA 50 to the blockchain network 17. The blockchain network 17 appends the first EKA 50 to the public ledger 62 maintained by the blockchain network 17. In this case, either the blockchain network 17 or the server 16 transfers the first EKA 50 to the computer 26 in the vehicle 14.

In the case that the system 10 does not include the blockchain network 17, the server 16 transfers the first EKA 50 directly to the computer 26 in the vehicle 14. The process 200 continues in a block 208.

In the block 208, the computer 26 in the vehicle 14 validates the first EKA 50. Validating an electronic record, as used herein, means to determine that the electronic record comes from an authorized source. This is typically done by comparing a signature of the electronic record with a public key. To validate the first EKA 50, the computer 26 utilizes an algorithm to determine that the signature on the first EKA 50 (based on the originator private key 60) corresponds with the originator public key included in the originator public certificate 56 included in the memory 15. For example, the computer 26 may utilize an algorithm based on the Digital Signature Algorithm (DSA) standard. As another example, the algorithm may be based on the Rivest-Shamir-Adleman (RSA) standard. In the case that the first EKA 50 is validated by the computer 26, the process 200 continues in a block 210. Otherwise, the process 200 ends.

In the block 210, the computer 26 updates the vehicle ledger 12 to include the first EKA 50. The vehicle ledger 12 is shown below.

Vehicle Ledger 12

First Electronic Key Authority 50

The process then continues in a block 212. In the block 212, the computer 26 in the vehicle 14 generates the first digital vehicle key 66. The computer 26 signs the first digital vehicle key 66 with the vehicle private key 52. The first digital vehicle key 66 includes the first vehicle public certificate 54 and is an electronic record that indicates receiving control over the vehicle 14.

The first vehicle public certificate 54 is signed by the originator private key 60. An example of the first vehicle public certificate 54 appears below.

First Vehicle Public Certificate 54

| | |
|---|---|
| VIN | Vehicle identification number |
| Vehicle Public Key | Digital code |
| Vehicle Description | Vehicle data |
| Date Time Manufactured | 2017-10-25T18:42:24.999 (example) |
| Signature | Signed by Originator Private Key 60 |

The first digital vehicle key 66 appears below.

First Digital Vehicle Key 66

| | |
|---|---|
| Vehicle Public Certificate | First Vehicle Public Certificate 54 |
| First User Access Device Serial | 1234553 |
| Number | |
| Date Time Created | 2017-10-25T18:42:24.999 |
| Signature | Signed by Vehicle Private Key 52 |

In a block 212, the computer 26 transfers the first digital vehicle key 66 to the first access device 20A. In the case that the system 10 utilizes blockchain network 17, transferring the first digital vehicle key 66 to the first access device 20A may include transferring the first digital vehicle key 66 to the blockchain network 17. In this case, either of the computer 26 or the blockchain network 17 may transfer the first digital vehicle key 66 to the first access device 20A. The process 200 continues in a block 214.

In the block 214, the first access device 20A validates the first digital vehicle key 66. Validating the first digital vehicle key 66 confirms that the first digital vehicle key 66 was received from a legitimate vehicle. In order to validate the first digital vehicle key 66, the first access device 20A checks the first digital vehicle key 66 against the originator public key included in the first vehicle public certificate 54. In the case that the first access device 20A determines that the first digital vehicle key 66 is valid, the process 200 continues in a block 216. Otherwise, the process 200 ends.

In the block 216, the first access device 20A stores the first digital vehicle key 66. The first access device 20A can use the first digital vehicle key 66 to access the vehicle 14, as described below with regard to the process 400. The process the 200 ends.

As noted above, in some cases, a document such as the first EKA 50 may be transferred to the vehicle 14 via the blockchain network 17. In these cases, the blockchain network 17 may validate the first EKA 50 prior to transferring the first EKA 50 to the vehicle 14. The blockchain network 17 (i.e., a computer included in the blockchain network 17) may utilize an algorithm to determine that the signature on the first EKA 50 corresponds with the originator public key included in the originator public certificate 56. In the case that the blockchain network 17 determines that the first EKA 50 is not valid, the blockchain network 17 may end the process 200.

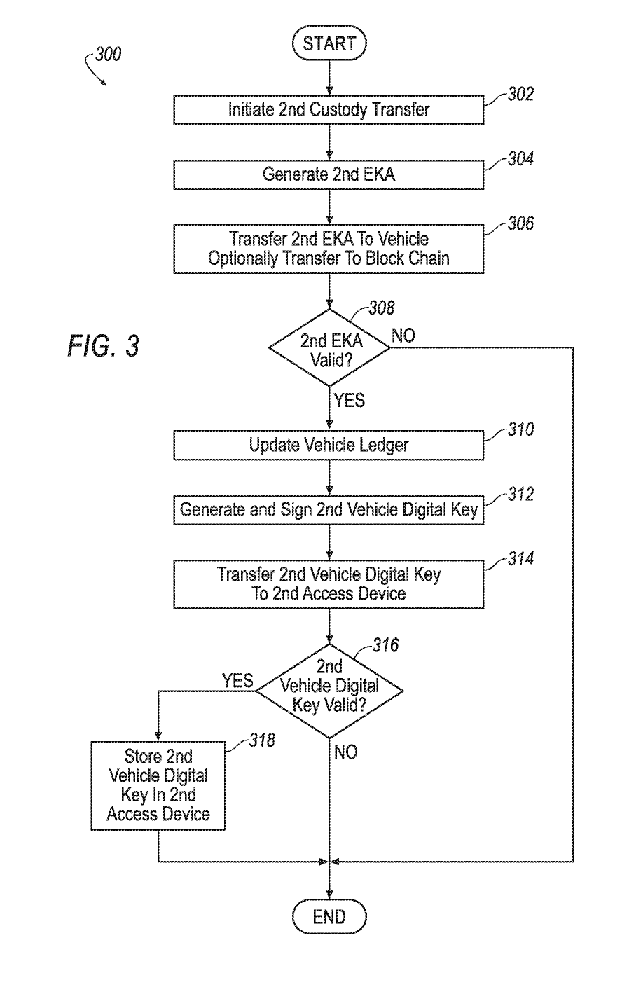

FIG. 3 is a diagram of an exemplary process 300 for transferring custody of the vehicle 14 from an (n−1)th user to an nth user, where n is the number of consecutive authorized users and n>1. For ease of illustration, the process 300 will be described for the case of n=2, i.e., transferring custody from a first user to a second user. The process 300 begins in a block 302.

In the block 302, the second user requests a transfer of custody of the vehicle 14 from the first user to the second user. A user that is transferring custody to another user can be referred to herein as a user having custody prior to a custody transfer. For example, the second user may supply data to the first user required to initiate a transfer of custody. The data includes, e.g., the second access device public certificate 74 for the second access device 20B, used by the second user. The first user initiates the transfer of custody by entering the data into a computer such as the server 16, or other computer 21 that is included in or communicatively coupled with the system 10. The second access device public certificate 74 is shown below.

Second Access Device Public Certificate 74

| | |
|---|---|
| Second Access Device 20B Serial | 1234554 |
| Number | |
| Second Access Device Public Key | digital code |
| Date/Time Manufactured | 2017-11-25T18:42:24.999 |
| Second user | Second user identification data |
| Signature | Signed by the Second Device Source |
| | Private Key |

The second access device public certificate 74 includes a serial number uniquely identifying the second access device 20B. The second access device public certificate 74 further includes a second access device public key. The second access device public key is a digital code. The second access device public key can be used, for example, by the vehicle 14 to confirm the identity of the second access device 20B when receiving commands. The second access device public key can also be used to encrypt data sent from the vehicle 14 to the second access device 20B. The second access device public certificate 74 may further include second user data such as name, address, etc. The second access device public certificate 74 is signed by an authorized entity, for example a source for the second access device 20B.

In addition to the second access device public certificate 74, other data may be entered into the server 16 or other computer 21 such as payment information, date of delivery of the vehicle 14, etc. The process 300 continues in a block 304.

In the block 304, the server 16 or other computer 21 generates the second electronic key authority (EKA) 84 and signs the second EKA 84 with the first access device private key 70. The second EKA 84 of this example is shown below.

Second Electronic Key Authority 84

| | |
|---|---|
| Granter Public Certificate | The Checksum of the First Access |
| Checksum | Device Public Certificate 72 |
| Granter Public Certificate | Serial number from the First Access |
| Serial Number | Device Public Certificate 72 |
| Date/Time | 2018-10-24T18:42:24.999 |
| VIN | Vehicle identification number |
| Second User Access Device | Second Access Device Public |
| Public Certificate | Certificate 74 |
| Signature | Signed by First Access Device |
| | Private Key 70 |

The second EKA 84 includes the checksum from the first access device public certificate 72, the serial number from the First Access Device Public Certificate 72, the vehicle identification number (VIN) for the vehicle 14, and the date and time of the transfer of custody. The second EKA 84 is signed based by the first access device private key 70. The process 300 continues in a block 306.

In the block 306, the server 16 or other computer 21 transfers the second EKA 84 to the computer 26 in the vehicle 14. The transfer may include an intermediate transfer to the blockchain network 17.

In the case that the transfer includes the blockchain network 17, the server 16 or other computer 21 transfers the second EKA 84 to the blockchain network 17. The blockchain network 17 appends the second EKA 84 to the public ledger 62 maintained by the blockchain network 17. The blockchain network 17, server 16 or other computer 21 transfers the second EKA 84 to the computer 26 in the vehicle 14.

In the case that the system 10 does not include the blockchain network 17, the server 16 or other computer 21 transfers the second EKA 84 directly to the computer 26 in the vehicle 14. The process 300 continues in a block 308.

In the block 308, the computer 26 in the vehicle 14 validates the second EKA 84. Referencing the vehicle ledger 12, the computer 26 first validates the first EKA 50 against the originator public certificate 56. In the case that the first EKA 50 validation is successful, the computer 26 utilizes an algorithm to determine that the signature (based on the first access device private key 70) in the second EKA 84 corresponds with the first access device public certificate 72 included in the first EKA 50. The algorithm may be based, for example, on the DSA or RSA standard, as noted above. In this manner, chain of custody is confirmed from the originator to the latest (in this case second) user. In the case that the both the first EKA 50 and second EKA 84 are validated by the computer 26, the process 300 continues in a block 310. In the case that either the validation of the first EKA 50 or second EKA 84 fails, the process 300 ends.

In subsequent transfers of custody, respective subsequent EKAs are appended to the vehicle ledger 12 and optionally the public ledger 62. In these cases, validating the most recently received EKA includes validating all EKAs in the chain of custody from the first EKA 50 to the most recently received EKA.

In the block 310, the computer 26 updates the vehicle ledger 12 to include the second EKA 84. The vehicle ledger 12, after being updated to include the second EKA 84, is shown below.

Vehicle Ledger 12

First Electronic Key Authority 50
Second Electronic Key Authority 84

The process then continues in a block 312. In the block 312, the computer 26 in the vehicle 14 generates the second digital vehicle key 68. The computer signs the second digital vehicle key 68 by the vehicle private key 52. The second digital vehicle key 68 includes the first vehicle public certificate 54 and is a record that indicates receiving control over the vehicle 14.

The first vehicle public certificate 54 is signed by the originator private key 60. An example of the first vehicle public certificate 54 appears below.

First Vehicle Public Certificate 54

| | |
|---|---|
| VIN | Vehicle identification number |
| Vehicle Public Key | Digital code |
| Vehicle Description | Vehicle data |
| Date Time Manufactured | 2017-10-25T18:42:24.999 |
| Signature | Signed by Originator Private Key 60 |

The second digital vehicle key 68 appears below.

Second Digital Vehicle Key 68

| | |
|---|---|
| Vehicle Public Certificate | First Vehicle Public Certificate 54 |
| Second User Access Device Serial | Unique number identifying the |
| Number | second user access device 20B |
| Date Time Created | 2018-10-25T18:42:24.999 |
| Signature | Signed by Vehicle Private Key 52 |

In a block 312, the computer 26 transfers the second digital vehicle key 68 to the second access device 20B. The process 300 continues in a block 314.

In the block 314, the second access device 20B validates the second digital vehicle key 68. The second access device 20B checks the second digital vehicle key 68 against the originator public key included in the first vehicle public certificate 54. In the case that the second access device 20B determines that the second digital vehicle key 68 is valid, the process 300 continues in a block 316. Otherwise, the process 300 ends.

In the block 316, the second access device 20B stores the second digital vehicle key 68. The second access device 20B can use the second digital vehicle key 68 to access the vehicle 14, as described below with regard to the process 400. The process the 300 then ends.

As noted above, in some cases, a document such as the second EKA 84 may be transferred to the vehicle 14 via the blockchain network 17. In these cases, the blockchain network 17 may validate the second EKA 84 prior to transferring the second EKA 84 to the vehicle 14. The blockchain network 17 (i.e., a computer included in the blockchain network 17) may utilize an algorithm to determine that the signature on the second EKA 84 corresponds with the first access device public certificate 72 included in the first EKA 50. In the case that the blockchain network 17 determines that the second EKA 84 is not valid, the blockchain network 17 may end the process 300.

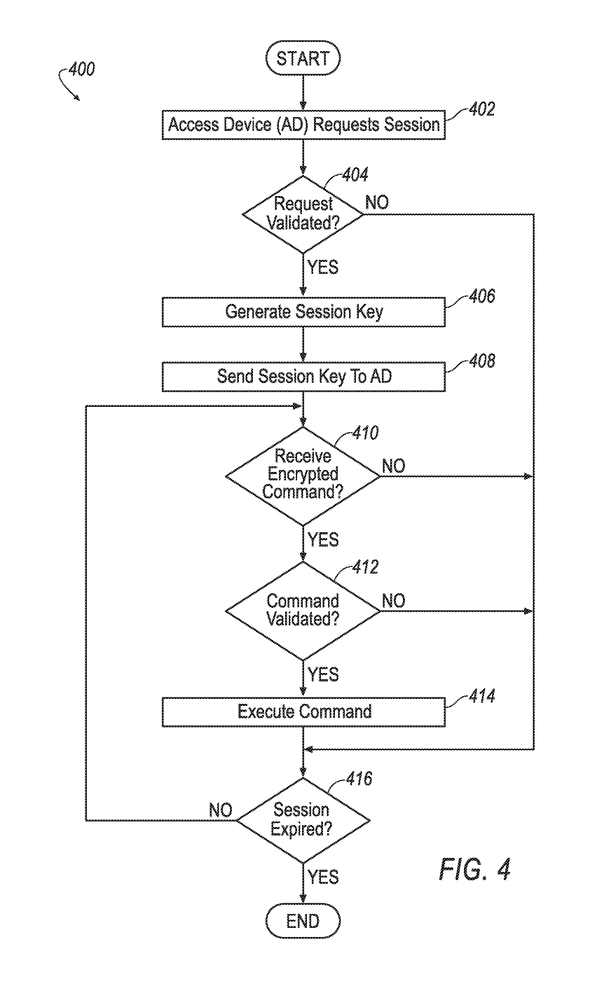

FIG. 4 is a diagram for an exemplary process 400 for accessing the vehicle 14 with the first access device 20A. The process 400 begins in a block 402.

In the block 402, the first access device 20A requests to open a session with the computer 26 in the vehicle 14. The session is a time period during which encrypted communications are opened between the first access device 20A and the computer 26. The computer 26 may be programmed to close the session after a first predetermined time, for example, two minutes from opening the session. Additionally or alternatively, the computer 26 may be programmed to close the session when, e.g., the computer 26 has not received a new message from the first access device 20A for a second predetermined period of time, for example, one minute. The encryption is based on a session key provided by the computer 26. The request may be initiated based on input from the first user. For example, the first user may push a button on the first access device 20A indicating that the user wants to unlock the vehicle 14. Based on the input from the first user, the first access device 20A may be programmed to send a request to open the session to the computer 26 in the vehicle 14. The request is signed with the first access device private key 70. The process 400 continues in a block 404.

In the block 404, the computer 26 validates the request received from the first access device 20A. The computer 26 validates signature in the request (i.e., the first access device private key 70) against the first access device public key. The first access device public key is included in the first access device public certificate 72 included in the first EKA 50. The first EKA 50 is stored in the vehicle ledger 12. In the case that the computer 26 validates the request, the process 400 continues in a block 406. Otherwise the process 400 ends.

In the block 406, the computer 26 generates a session key. The session key is generated based on the first access device public key. The process 400 continues in a block 408.

In the block 408, the computer 26 transfers the session key to the first access device 20A. The transfer of the session key from the computer 26 to the first access device 20A may be encrypted based on the first access device public key. Transferring the session key to the first access device 20A opens the session. The process 400 continues in a block 410.

In the block 410, the computer 26 determines whether the computer 26 has received an encrypted command based on the session key. In the case that the no encrypted command has been received, the process 400 continues in a block 416. In the case that an encrypted command has been received, the process 400 continues in a block 412.

In the block 412, the computer 26 validates the command. The computer 26 determines that the command has been encrypted with the session key. In the case that the command has been encrypted with the session key, the computer 26 decodes the command. The process 400 continues in the block 414. In the case that the computer 26 determines that the command was not encrypted with the session key, the process 400 continues in the block 416.

In the block 414, the computer 26 executes the command. For example, the command may be to unlock the vehicle 14. In this case, the computer 26 may send commands to one or more actuators included in one or more subsystems 30. Based on the commands, the one or more actuators may actuate one or more locks to an unlocked position. The process 400 continues in a block 416.

In the block 416, the computer 26 determines if the session is expired. For example, the computer 26 may be programmed to close the session a predetermined time after the session was opened. Limiting the time that a session is open reduces the likelihood that the session key can be captured by an unauthorized party and used to access the vehicle 14. In the case that the session has not expired, the process 400 continues in the block 410. Otherwise, the process 400 ends.

### CONCLUSION

Computers such as those discussed herein generally each include instructions executable by one or more computers such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored in files and transmitted using a variety of computer-readable media. A file in a computer is generally a collection of data stored on a computer readable medium, such as a storage medium, a random-access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exact described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

We claim:

1. A computer comprising a processor; and a memory, the memory storing instructions executable by the processor such that the processor is programmed to:
receive custody data for a vehicle;
store the custody data in a vehicle ledger;
receive a request to open encrypted communications between an access device and the computer based on a session key;
validate the request based on the custody data; and
control the vehicle based on the encrypted communications.

2. The computer of claim 1, wherein the custody data includes a public key for the access device, and the request is signed by a private key for the access device.

3. The computer of claim 1, wherein the custody data is received from a blockchain network.

4. The computer of claim 1, wherein the processor is further programmed to:
validate the custody data.

5. The computer of claim 4, wherein the custody data is signed by a private key from a user having custody of the vehicle prior to a custody transfer, and validating the custody data is based at least in part on the custody data being signed by the private key.

6. The computer of claim 5, wherein validating the custody data is based on a public key from the user having custody to the vehicle prior to the custody transfer stored in the memory of the computer prior to receiving the custody data.

7. The computer of claim 1, wherein the processor is further programmed to:
generate a digital vehicle key signed by a vehicle private key; and
provide the digital vehicle key to the access device.

8. The computer of claim 7, wherein providing the digital vehicle key to the access device includes storing the digital vehicle key in a blockchain system.

9. The computer of claim 1, wherein the processor is further programmed to:
generate the session key; and
send the session key to the access device.

10. The computer of claim 1, wherein the custody data includes an electronic key authority, signed by a private key of a user having custody of the vehicle prior to a custody transfer of the vehicle.

11. The computer of claim 1, wherein the vehicle ledger includes custody data from each entity that previously had custody of the vehicle.

12. A method executable by a processor in a computer comprising:
receiving custody data for a vehicle;
storing the custody data in a vehicle ledger;
receiving a request to open encrypted communications between an access device and the computer based on a session key;
validating the request based on the custody data; and
controlling the vehicle based on the encrypted communications.

13. The method of claim 12, wherein the custody data includes a public key for the access device, and the request is signed by a private key for the access device.

14. The method of claim 12, wherein the custody data is received from a blockchain network.

15. The method of claim 12, further comprising:
validating the custody data.

16. The method of claim 15, wherein the custody data is signed by a private key from a user having custody to the vehicle prior to a custody transfer of the vehicle and validating the custody data is based at least in part on the custody data being signed by the private key.

17. The method of claim 16, wherein validating the custody data is further based on a public key from the user having custody to the vehicle prior to the custody transfer stored in a memory of the computer prior to receiving the custody data.

18. The method of claim 12, further comprising:
generating a digital vehicle key signed by a vehicle private key; and
providing the digital vehicle key to the access device.

19. The method of claim 12, further comprising:
generating the session key; and
sending the session key to the access device.

20. The method of claim 12, wherein the vehicle ledger includes custody data from each entity that previously had custody of the vehicle.
